(19) United States
(12) Patent Application Publication
(10) Pub. No.: US 2024/0160087 A1
(43) Pub. Date: May 16, 2024

(54) MULTIFUNCTIONAL LENS COVER, PHOTOGRAPHIC FILTER STRUCTURE AND PHOTOGRAPHIC DEVICE

(71) Applicant: SHENZHEN NEEWER TECHNOLOGY CO. LTD, Shenzhen (CN)

(72) Inventors: Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/150,966

(22) Filed: Jan. 6, 2023

(30) Foreign Application Priority Data
Nov. 16, 2022 (CN) 202223052049.0

(51) Int. Cl. G03B 11/04; G02B 7/00

(52) U.S. Cl. CPC G03B 11/041; G02B 7/006

(57) ABSTRACT

Disclosed are a multifunctional lens cover, a photographic filter structure and a photographic device. The multifunctional lens cover includes a conversion structure, a filter body and a cover structure. The conversion structure is detachably connected to a lens body, the filter body is detachably connected to the conversion structure, the cover structure includes a first connecting portion and a second connecting portion, the first connecting portion is provided with a first magnetic member to magnetically attract the lens structure, and/or the second connecting portion is provided with a thread structure to be screwed to the lens structure.

### CROSS-REFERENCE TO RELATED APPLICATIONS

This application claims priority to Chinese Patent Application No. 202223052049.0, filed on Nov. 16, 2022, the entire contents of which are incorporated herein by reference.

### TECHNICAL FIELD

The present disclosure relates to the technical field of photographic equipment, and in particular to a multifunctional lens cover, a photographic filter structure and a photographic device.

### BACKGROUND

In order to protect the lens or enable the optical equipment to achieve a variety of different optical effects, optical lenses such as ultraviolet (UV) mirrors, starlight mirrors, polarizers, and filters are installed in front of the lens of the existing optical equipment such as cameras, video cameras, and projectors.

However, the existing connection methods among lenses, filters and lens covers are mostly interference fit, and the lens cover has a certain degree of elasticity, but there are certain defects in the interference fit. The newly produced lens cover has good elasticity and strong friction, the lens cover is difficult to remove. After the long-term use, the elasticity of the lens cover will gradually fail, so the lens cover is easy to lose, which will affect the daily protection of the device.

### SUMMARY

The main objective of the present disclosure is to provide a multifunctional lens cover, aiming to increase the connecting reliability of the cover structure in the multifunctional lens cover.

To achieve the above purpose, the present disclosure provides a multifunctional lens cover, including a cover structure. A conversion structure is detachably connected to a lens body, the filter body is detachably connected to the conversion structure, the cover structure includes a first connecting portion and a second connecting portion, the first connecting portion is provided with a first magnetic member to magnetically attract the lens structure, and/or the second connecting portion is provided with a thread structure to be screwed to the lens structure.

In an embodiment, the cover structure includes a cover body, the first connecting portion is provided at one side of the cover body, and the second connecting portion extends from a side of the first connecting portion away from the cover body.

In an embodiment, the first magnetic member is a ring magnet.

In an embodiment, the first connecting portion includes at least two first magnetic members, and the at least two first magnetic members are evenly disposed on the first connecting portion along a circumferential direction of the cover body.

In an embodiment, the thread structure of the second connecting portion is an internal thread.

In an embodiment, the thread structure of the second connecting portion is an external thread.

In an embodiment, an outer diameter of the first connecting portion is larger than an outer diameter of the second connecting portion.

The present disclosure further provides a photographic filter structure, including the multifunctional lens cover, the conversion structure and the filter body as described above. The conversion structure is detachably connected to a lens body, and the filter body is detachably connected to the conversion structure. The filter body includes a filter, a second connecting portion and a filter fixing portion. The filter is fixed on the filter fixing portion. The third connecting portion is arranged on one side of the filter fixing portion, the third connecting portion is sleeved on the second connecting portion, and the third connecting portion is screwed to the second connecting portion.

In an embodiment, the filter body further includes a fourth connecting portion, the conversion structure includes a fifth connecting portion extending away from the lens body, and the fourth connecting portion is abutted against an inside of the fifth connection portion.

In an embodiment, a fixing groove is formed on an inner side of the filter fixing portion, and the filter is confined and fixed in the fixing groove.

In an embodiment, a second magnetic member is provided in the filter, the conversion structure is provided with a second magnetic member, the first magnetic member, the second magnetic member and the third magnetic member are magnetically attract to each other.

In an embodiment, a plurality of filter bodies are provided and are stacked in sequence on the conversion structure.

In an embodiment, an anti-skid chequer is disposed around a circumferential edge of the conversion structure, the filter body and the cover.

The present disclosure further provides a photographic device, including the photographic filter structure described above.

In technical solutions of the present disclosure, the conversion structure is detachably connected to the lens body, thereby facilitating the installation of the filter body, and the cover structure is provided with a first connection portion and a second connection portion. There are two methods to connect the cover structure with the filter body. The first is that the cover structure is magnetically connected with the filter body through the magnetic member of the first connecting portion. In an embodiment, the filter body can also be provided with a magnetic member. In an embodiment, the frame of the filter body can be made of metal, and can be magnetically attracted to the magnetic member of the cover structure. The second is that the cover structure is screwed to the filter body through the thread structure of the second connecting portion extending toward the filter body, and the magnetic member of the first connecting portion can also perform an auxiliary magnetic attraction and fixing at the same time. The two different connection methods of the cover structure and the filter body can be applied to different scenarios. Specifically, when the photographer shoots outdoors, it is necessary to remove the cover structure from time to time and take a shoot. The first method can be adopted for the photographer to quickly remove the cover structure and take a snapshot. It is convenient to disassembly and has sufficient reliability. It can be understood that if the removal steps of the cover structure are too complicated, or the pressure of the cover structure is too high and it is difficult to remove, it may cause the photographer to miss the opportunity to take pictures, which will greatly affect the user's experience. When the camera is standby, it may not be needed for a long time. At this time, the cover structure can protect the filter body of the camera through the second method. The second method has the threaded connection and magnetic attraction connection at the same time, which greatly improves the reliability of the connection between the cover structure and the filter body.

### BRIEF DESCRIPTION OF THE DRAWINGS

In order to illustrate the technical solutions in the embodiments of the present disclosure or in the related art more clearly, the following briefly introduces the accompanying drawings required for the description of the embodiments or the prior art. Obviously, the drawings in the following description are only part of embodiments of the present disclosure. For those of ordinary skill in the art, other drawings can also be obtained according to the structures shown in these drawings without any creative effort.

FIG. 1 is a schematic structural view of a cover structure of a multifunctional lens cover according to an embodiment of the present disclosure.

FIG. 2 is a side view of the multifunctional lens cover according to an embodiment of the present disclosure.

FIG. 3 is a sectional view of the multifunctional lens cover according to an embodiment of the present disclosure.

FIG. 4 is a sectional view of the multifunctional lens cover according to an embodiment of the present disclosure.

FIG. 5 is an exploded view of a photographic filter structure according to an embodiment of the present disclosure.

FIG. 6 is a sectional view of the photographic filter structure according to the present disclosure.

FIG. 7 is an exploded view of a photographic filter structure according to an embodiment of the present disclosure.

### DETAILED DESCRIPTION OF THE EMBODIMENTS

The technical solutions of the embodiments of the present disclosure will be described in more detail below with reference to the accompanying drawings. It is obvious that the embodiments to be described are only some rather than all of the embodiments of the present disclosure. All other embodiments obtained by persons skilled in the art based on the embodiments of the present disclosure without creative efforts shall fall within the scope of the present disclosure.

It should be noted that if there are directional indications, such as up, down, left, right, front, back, etc., involved in the embodiments of the present disclosure, the directional indications are only used to explain a certain posture as shown in the accompanying drawings. If the specific posture changes, the directional indication also changes accordingly.

Unless otherwise clearly specified and limited, the terms “connection” and “fixation” in the present disclosure should be interpreted in a broad sense, for example, “fixation” can be a fixed connection, a detachable connection, or an integral body. It can be a mechanical connection or an electrical connection, it can be a direct connection or an indirect connection through an intermediary, and it can be an internal communication between two elements or an interaction relationship between two elements, unless otherwise clearly defined. Specific meanings of the above terms in this disclosure can be understood by persons skilled in the art according to specific situations.

In addition, if there are descriptions related to “first”, “second”, etc. in the embodiments of the present disclosure, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the disclosure includes three parallel scenarios. For example, “A and/or B” includes only A, or only B, or both A and B. In addition, the technical solutions between the various embodiments can be combined with each other, but must be based on the realization by those of ordinary skill in the art. When the combination of technical solutions is contradictory or cannot be realized, it should be considered that the combination of such technical solutions does not exist or fall within the scope of protection claimed in this disclosure.

The present disclosure provides a multifunctional lens cover, which is detachably covered on the lens structure. It should be noted that, in an embodiment, the lens structure is the filter body 2.

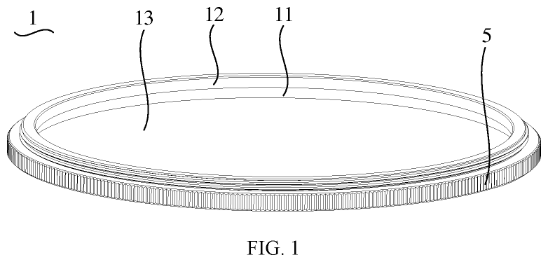

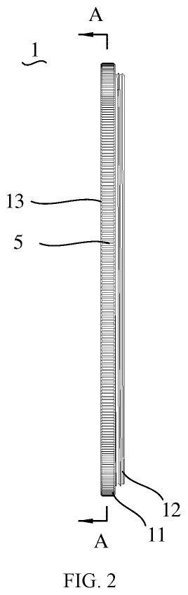

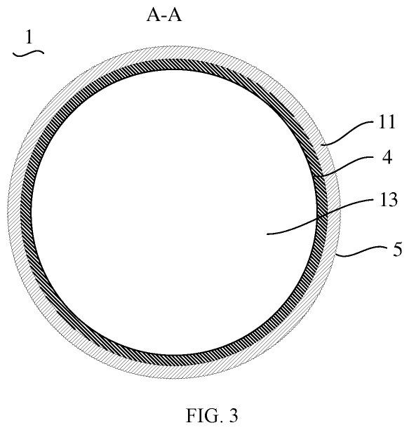

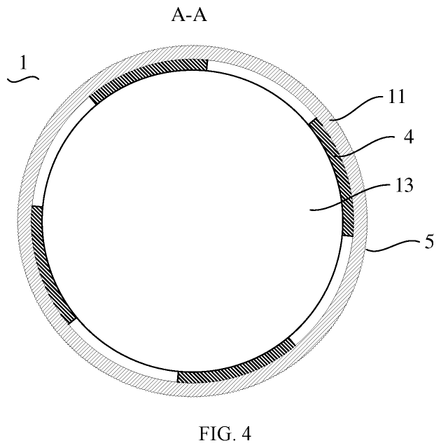

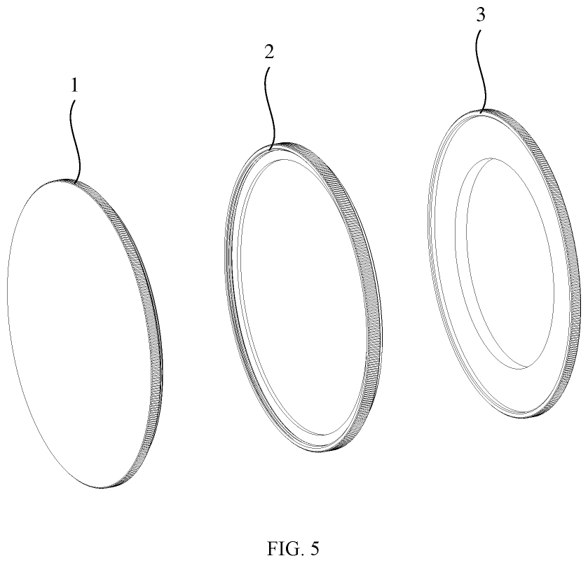

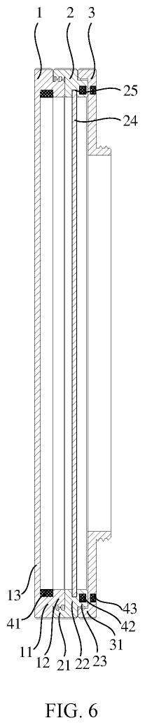

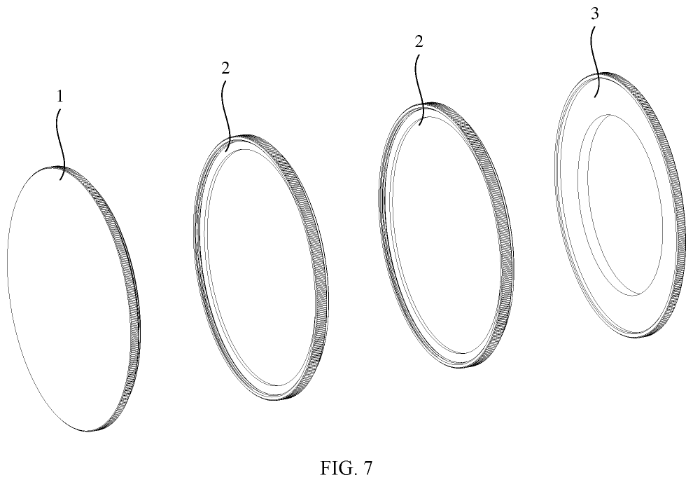

Referring to FIG. 1 to FIG. 7, in an embodiment, the multifunctional lens cover includes a cover structure 1. A conversion structure 3 is detachably connected to the lens body, the filter body 2 is detachably connected to the conversion structure 3, the cover structure 1 is provided with a first connecting portion 11 and a second connecting portion 12, the first connecting portion 11 is provided with a first magnetic member 41 to magnetically attract the filter body 2, and the second connecting portion 12 is provided with a thread structure to be screwed to the filter body 2.

The conversion structure 3 provided by the present disclosure is detachably connected to the lens body, thereby facilitating an installation of the filter body 2, and the cover structure 1 is provided with a first connection portion 11 and a second connection portion 12. There are two methods to connect the cover structure 1 to the filter body 2. The first is that the cover structure 1 is magnetically connected with the filter body 2 through a first magnetic member 41 of the first connecting portion 11. In an embodiment, the filter body 2 can also be provided with the first magnetic member 41. In an embodiment, a frame of the filter body 2 can be made of metal, and can be magnetically attracted to the first magnetic member 41 of the cover structure 1. The second is that the cover structure 1 is screwed to the filter body 2 through a thread structure of the second connecting portion 12 extending toward the filter body 2, and the first magnetic member 41 of the first connecting portion 11 can also perform an auxiliary magnetic attraction and fixing at the same time. The two different connection methods of the cover structure 1 and the filter body 2 can be applied to different usage scenarios. Specifically, when the photographer is shooting outdoors, it is necessary to remove the cover structure 1 from time to time and shoot. The first method can be adopted for the photographer to quickly remove the cover structure 1 and take a snapshot. It is convenient to disassembly and has sufficient reliability. It can be understood that if the removal steps of the cover structure 1 are too complicated, or the pressure of the cover structure 1 is too high and it is difficult to remove, it may cause the photographer to miss the opportunity to take pictures, which will greatly affect the user's experience. When the camera is standby, it may not be needed for a long time. At this time, the cover structure 1 can protect the filter body 2 of the camera through the second method. The second method has the threaded connection and magnetic attraction connection at the same time, which greatly improves the reliability of the connection between the cover structure 1 and the filter body 2.

In an embodiment, the cover structure 1 includes a cover body 13, the first connecting portion 11 is provided at one side of the cover body 13, and the second connecting portion 12 extends from a side of the first connecting portion 11 away from the cover body 13. A threaded connection between the cover structure 1 and the filter body 2 can be realized through a threaded structure of the second connecting portion 12, so that the cover structure 1 can be reliably covered on the filter body 2 and protect a filter 24 inside the filter body 2. In an embodiment, the first magnetic member 41 on the first connecting portion 11 is a ring magnet which has a better magnetic adsorption ability. In an embodiment, the first connecting portion 11 includes at least two first magnetic members 41, and the at least two first magnetic members 41 are evenly disposed on the first connecting portion 11 along a circumferential direction of the cover body 13. Through the above structure, materials of the first magnetic member 41 are less required, thereby reducing the cost of the multifunctional lens cover.

The thread structure of the second connecting portion 12 includes three types, the first type an internal thread, the second type is an external thread, and the third type is that the thread structure has both internal and external threads. The cover structure 1 with the internal thread can be fitted to the filter body 2 with the external thread, the cover structure 1 with the external thread structure can fitted to the filter body 2 with the internal thread, and the cover structure 1 with both external and internal threads can be fitted to the filter body 2 with external thread and the filter body 2 with the internal thread at the same time. In this way, the cover structure 1 has a higher matching effect and can meet structural requirements of different filter bodies 2.

An outer diameter of the first connecting portion 11 is larger than the outer diameter of the second connecting portion 12. In an embodiment, the cover body is embedded, the thread of the second connecting portion 12 is the external thread, and the second connecting portion 12 is threaded and fastened by embedding. In this way, the second connecting portion 12 after installed of the cover structure 1 will not squeeze the filter body 2, instead the second connecting portion 12 can support a third connecting portion 21 when the filter body 2 is squeezed by an external force, thereby ensuring a safety of the filter 24 in the filter body 2.

The present disclosure also provides a photographic filter structure, the photographic filter structure includes the multifunctional lens cover, a specific structure of the multifunctional lens cover refers to the above-mentioned embodiments, because the photographic filter structure has adopted all the technical solutions of all the above-mentioned embodiments, it has at least all the beneficial effects brought by the technical solutions of the above embodiments, which will not be repeated here. The photographic filter structure further includes the conversion structure 3 and the filter body 2, the cover structure 1 is detachably connected to the filter body 2, and the filter body 2 is detachably connected to the conversion structure 3.

The filter body 2 includes the third connecting portion 21 and a filter fixing portion 22, the third connecting portion 21 is arranged on one side of the filter fixing portion 22, the third connecting portion 21 is sleeved on the second connecting portion 12, and the third connecting portion 21 is screwed to the second connecting portion 12. A function of the filter fixing part 22 is mainly for fixing the filter 24, and the third connecting portion 21 is mainly for fixing the second connecting portion 12 of the cover structure 1.

Further, the filter body 2 further includes a fourth connecting portion 23, the conversion structure 3 includes a fifth connecting portion 31 extending away from the lens body, and the fourth connecting portion 23 is abutted against an inside of the fifth connection portion 31.

It should be noted that, in an embodiment, there exists a connection relationship among the second connection portion 12, the third connection portion 21, the fourth connection portion 23 and the fifth connection portion 31. Specifically, the third connecting portion 21 is sleeved on the second connecting portion 12, and the fifth connecting portion 31 is sleeved on the fourth connecting portion 23. In this way, the third connecting portion 21 is located outside, that is, a pressure from the third connecting portion 21 will not directly act on the filter fixing part 22. The fourth connecting portion 23 and the fifth connecting portion 31 are non-threaded, that is, there is no rigid connection, so the pressure from the fourth connecting portion 23 will act on the fifth connecting portion 31 first, and will not directly act on the filter fixing part 22. In conclusion, the filter fixing part 22 is located in a relatively proper position, which can avoid the force directly acting on the third connecting portion 21 and the fourth connecting portion 23, and can effectively prevent the filter 24 from being crushed due to an excessive pressure on the filter fixing portion 22.

In an embodiment, a fixing groove 25 is formed on an inner side of the filter fixing portion 22, and the filter 24 is confined and fixed in the fixing groove 25. A structure of the fixing groove 25 can effectively confine and fix the filter 24, which improves a structural stability of a connection of the filter 24.

In an embodiment, settings of the first magnetic member 41 include at least three situations, the first is that the filter body 2 is provided with a second magnetic member 42, the second is that the conversion structure 3 is provided with a third magnetic member 43, the third is that the filter body 2 is provided with the second magnetic member 42 and the conversion structure 3 is provided with the third magnetic member 43.

Further, a plurality of filter bodies 2 are provided and are stacked in sequence on the conversion structure 3. In an embodiment, the filter body 2 is provided with the first magnetic piece 41, so that when the plurality of filter bodies 2 need to cooperate together, a magnetic attraction between the first magnetic members 41 can make the plurality of filters 24 are stacked. In this way, the photographic device can use the plurality of filters 24 to achieve a purpose of photography. Specifically, the realization of the stack is to facilitate the magnetic connection between different filters 24 through the third connection portion 21 of one filter body 2 sleeved on the fourth connection portion 23 of another filter body 2. The first magnetic member 41 can be disposed on the third connecting portion 21, the fourth connecting portion 23, and can also be disposed on the third connecting portion 21 and the fourth connecting portion 23 at the same time.

Further, an anti-skid chequer 5 is disposed around a circumferential edge of the conversion structure 3, the filter body 2 and the cover structure 1. The anti-skid chequer 5 can prevent slipping and improve friction between hands and the conversion structure 3, the filter body 2 and the cover structure 1, thereby making the connection between threads easier.

The present disclosure also provides a photographic device. In an embodiment, the photographic device includes a multifunctional lens cover. Specifically, the multifunctional lens cover is arranged on a lens of the photographic device. In an embodiment, the photographic device includes the photographic filter structure, and the photographic filter structure is detachably mounted on the lens of the photographic device.

The above descriptions are only embodiments of the present disclosure, and are not intended to limit the scope of the present disclosure. Under the concept of the present disclosure, any equivalent structural transformations made by using the contents of the description and drawings of the present disclosure, or direct/indirect disclosures in other related technical fields are included in the scope of the present disclosure.

What is claimed is:

1. A multifunctional lens cover detachably covering a lens structure, comprising:
a cover structure provided with a first connecting portion and a second connecting portion,
wherein the first connecting portion is provided with a first magnetic member to magnetically attract the lens structure, and/or the second connecting portion is provided with a thread structure to be screwed to the lens structure.

2. The multifunctional lens cover of claim 1, wherein the cover structure comprises a cover body, the first connecting portion is provided at one side of the cover body, and the second connecting portion extends from a side of the first connecting portion away from the cover body.

3. The multifunctional lens cover of claim 2, wherein the first magnetic member is configured as a ring magnet.

4. The multifunctional lens cover of claim 2, wherein the first connecting portion comprises at least two first magnetic members, and the at least two first magnetic members are evenly disposed on the first connecting portion along a circumferential direction of the cover body.

5. The multifunctional lens cover of claim 2, wherein the thread structure of the second connecting portion is an internal thread.

6. The multifunctional lens cover of claim 2, wherein the thread structure of the second connecting portion is an external thread.

7. The multifunctional lens cover of claim 1, wherein an outer diameter of the first connecting portion is larger than an outer diameter of the second connecting portion.

8. The multifunctional lens cover of claim 1, wherein an anti-skid chequer is disposed around a circumferential edge of the cover structure.

9. A photographic filter structure, comprising the multifunctional lens cover of claim 1.

10. A photographic device, comprising the photographic filter structure of claim 9.
